(19) United States
(12) Patent Application Publication
(10) Pub. No.: US 2015/0084834 A1
(43) Pub. Date: Mar. 26, 2015

(54) POSITIVE CONTACT ANTENNA PUSH PIN

(71) Applicant: PC-TEL, Inc., Bloomingdale, IL (US)

(72) Inventor: James Giacobazzi, Bloomingdale, IL (US)

(21) Appl. No.: 14/493,547

(22) Filed: Sep. 23, 2014

Related U.S. Application Data
(60) Provisional application No. 61/881,187, filed on Sep. 23, 2013.

(51) Int. Cl. H01R 13/24; H01Q 1/50

(52) U.S. Cl. CPC H01R 13/2464; H01Q 1/50
USPC 343/906; 439/884

(57) ABSTRACT

A positive contact antenna push pin, an antenna push pin assembly that includes a positive contact antenna push pin, and an antenna that includes an antenna push pin assembly with a positive contact antenna push pin are provided. The positive contact antenna push pin can include a head and a shaft adjacent to the head, the shaft having a major axis along a length thereof and a minor axis along a width thereof, wherein a surface of a base of the shaft is non-parallel and non-perpendicular to both the major axis and the minor axis of the shaft.

### CROSS-REFERENCE TO RELATED APPLICATIONS

This application claims priority to U.S. Provisional Patent Application No. 61/881,187 filed Sep. 23, 2013 and titled “Positive Contact Antenna Push Pin”. U.S. Application No. 61/881,187 is hereby incorporated by reference.

### FIELD

The present invention relates generally to antennas. More particularly, the present invention relates to a positive contact antenna push pin.

### BACKGROUND

Push pins for contacts in antennas have a component of arbitrary impedance due to the randomness of the true point of electrical contact in the push pin assembly. At low frequencies, this is a small problem. However, at higher frequencies, this problem can cause significant performance changes as the antennas are mechanically shocked during normal operation.

For example, FIG. 1A is an exploded view of an antenna push pin assembly 100 known in the art, and FIG. 1B is a cross-sectional view of the antenna push pin assembly 100. As seen, the antenna push pin assembly 100 includes a housing 110, a spring 120, a pin retainer 130, and a contact pin 140. The spring 120 and at least a portion of the contact pin 140 can be disposed within the housing 110 and retained in place within the housing 110 by disposing the pin retainer 130 in the housing 110 and around at least a portion of the contact pin 140 in the housing 110. When assembled, the spring 120 and the contact pin 140 can be compressed and released to move within the housing.

FIG. 2 is a cross-sectional view of an antenna 150 that includes an antenna push pin assembly 100 known in the art engaged by an antenna mount 160. When the contact pin 140 is not engaged, neither the spring 120 nor the contact pin 140 is compressed within the housing 110, and the contact pin 140 fails to contact the side wall of the housing 110. However, when the contact pin 140 is engaged, for example, by the antenna mount 160 pressing and/or pushing on the base 145 of the contact pin 140, the contact pin 140 compresses the spring 120 and moves within the housing 110.

As seen in FIGS. 1A, 1B, and 2, the base of known contact pins, for example, base 145 of contact pin 140, has a substantially straight, flat surface that is perpendicular to a dominant axis of the pin 140. Accordingly, when the antenna mount 160 engages the contact pin 140, the entire surface of the base 145 is flush with the antenna mount 160. However, as discussed above, when the antenna pin 140 is engaged, the contact point between the antenna pin 140 and the side wall of the housing 110 is random and sometimes, the antenna pin 140 may not even directly contact the side wall of the housing 110. Indeed, the antenna pin 140 may only contact the housing 110 via the spring 120. Accordingly, the contact point between an antenna pin 140 known in the art and the housing 110 in which the pin 140 is disposed is random and arbitrary and cannot be repeated each time the antenna pin 140 is engaged. Such randomness creates an unpredictable and unreliable antenna.

The problems with known antenna push pin assemblies discussed above have been largely ignored. Accordingly, performance degradation has been tolerated in the industry. However, as communication systems are moving toward higher frequencies, and multiple carriers are being placed on a single antenna, the arbitrary contact point in known antenna push pin assemblies is a sizeable problem that can no longer be ignored. Therefore, the situation must be addressed.

In view of the above, there is a need for an improved antenna push pin assembly.

### BRIEF DESCRIPTION OF THE DRAWINGS

FIG. 1A is an exploded view of an antenna push pin assembly known in the art;

FIG. 1B is a cross-sectional view of an antenna push pin assembly known in the art;

FIG. 2 is a cross-sectional view of an antenna that includes an antenna push pin assembly known in the art engaged by an antenna mount;

FIG. 3A is a side view of an antenna push pin assembly that includes a positive contact antenna push pin in accordance with disclosed embodiments;

FIG. 3B is a cross-sectional view of an antenna push pin assembly that includes a positive contact antenna push pin in accordance with disclosed embodiments;

FIG. 4 is a side view of a positive contact antenna push pin in accordance with disclosed embodiments;

FIG. 5 is a cross-sectional view of an antenna that includes an antenna push pin assembly with a positive contact antenna push pin engaged by an antenna mount in accordance with disclosed embodiments; and

FIG. 6 is a cross-sectional view of an antenna that includes an antenna push pin assembly with a positive contact antenna push pin engaged by an antenna mount in accordance with disclosed embodiments.

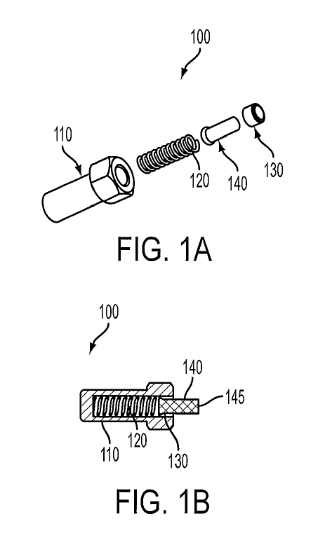

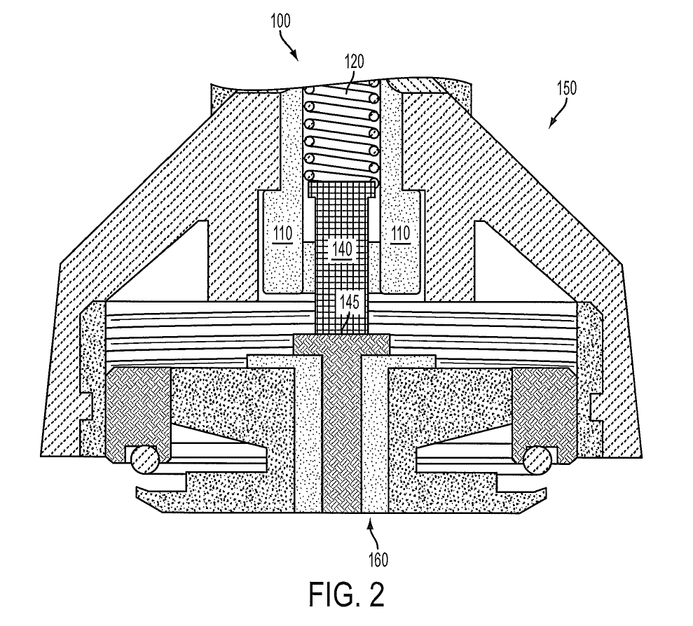

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include a positive contact antenna push pin, an antenna push pin assembly that includes a positive contact antenna push pin, and an antenna that includes an antenna push pin assembly with a positive contact antenna push pin.

In accordance with disclosed embodiments, a positive contact antenna push pin can include a base with a surface that is angled and/or mitered so as to be slightly offset of 90 degrees. Angling and/or mitering the base of the positive contact antenna push pin can bias the positive contact antenna push pin and/or an antenna push pin assembly of which the positive contact push pin is a part so that the positive contact antenna push pin contacts the side wall of the assembly housing at a known and repeatable electrical contact point, thereby eliminating and/or substantially reducing the randomness observed in known antenna push pin assemblies. For example, when assembled in an antenna push pin assembly and engaged, for example, by another portion of an antenna of which the assembly is a part pressing and/or pushing on the angled and/or mitered surface of the base, the positive contact antenna push pin can move within the housing and contact the side wall of the housing at a known contact point that can be repeated over time.

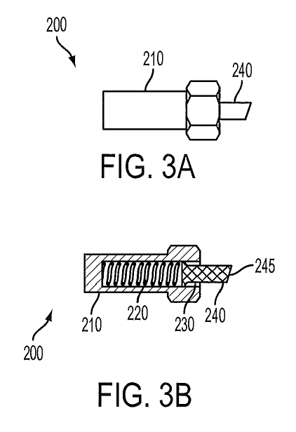

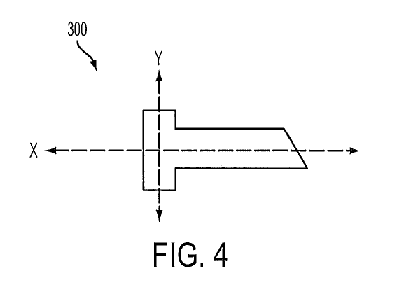

FIG. 3A is a side view of an antenna push pin assembly 200 that includes a positive contact antenna push pin 240 in accordance with disclosed embodiments, and FIG. 3B is a cross-sectional view of the antenna push pin assembly 200. Furthermore, FIG. 4 is a side view of a positive contact antenna push pin 300 in accordance with disclosed embodiments identifying major (X) and minor (Y) axes of the push pin 300. As seen in FIG. 4, the X axis of positive contact antenna push pins disclosed herein can be a central, major, longitudinal, dominant axis of the push pin, and the Y axis of positive contact antenna push pins disclosed herein can be a minor axis of the push pins.

The antenna push pin assembly 200 can include a housing 210, a spring 220, a pin retainer 230, and the positive contact antenna push pin 240. A surface of the base 245 of the positive contact antenna push pin 240 can be angled and/or mitered as described and disclosed above and herein.

The spring 220 and at least a portion of the positive contact antenna push pin 240 can be disposed within the housing 210 and retained in place within the housing 210 by disposing the pin retainer 230 in the housing 210 and around at least a portion of the positive contact antenna push pin 240 in the housing 210. When assembled, the spring 220 and the positive contact antenna push pin 240 can be compressed and released to move within the housing.

When the positive contact antenna pin 240 is not engaged, neither the spring 220 nor the positive contact antenna push pin 240 is compressed within the housing 220, and the positive contact pin 240 fails to contact the side wall of the housing 210. However, when the positive contact antenna push pin 240 is engaged, for example, by another portion of an antenna of which the assembly 100 is a part pressing and/or pushing on the base of the positive contact antenna push pin 210, the positive contact antenna push pin 240 can compress the spring 220, move within the housing 210, and contact the side wall of the housing 210 at a repeatable and predictable contact point. That is, in some embodiments, because the surface of the base 245 of the positive contact antenna push pin 240 is angled, when the other portion of the antenna presses or pushes on the positive contact antenna push pin 240, the other portion of the antenna is not flush with the entire surface of the base 245, thereby biasing the positive contact antenna push pin 240 and the movement thereof within the housing 210 and thereby causing the positive contact antenna push pin 240 to contact the housing 210 of the assembly 200 at the predictable contact point each time the positive contact antenna push pin 240 is engaged.

It is to be understood that the exact angle and shape of the surface of the base of the positive contact antenna push pin disclosed herein are not limitations of the disclosed embodiments. Instead, the surface of the base of the positive contact antenna push pin disclosed herein can have any shape and/or angle that would cause the positive contact antenna push pin to be biased within the antenna push pin assembly and to contact the side wall of the antenna push pin assembly housing at a repeatable contact point when engaged.

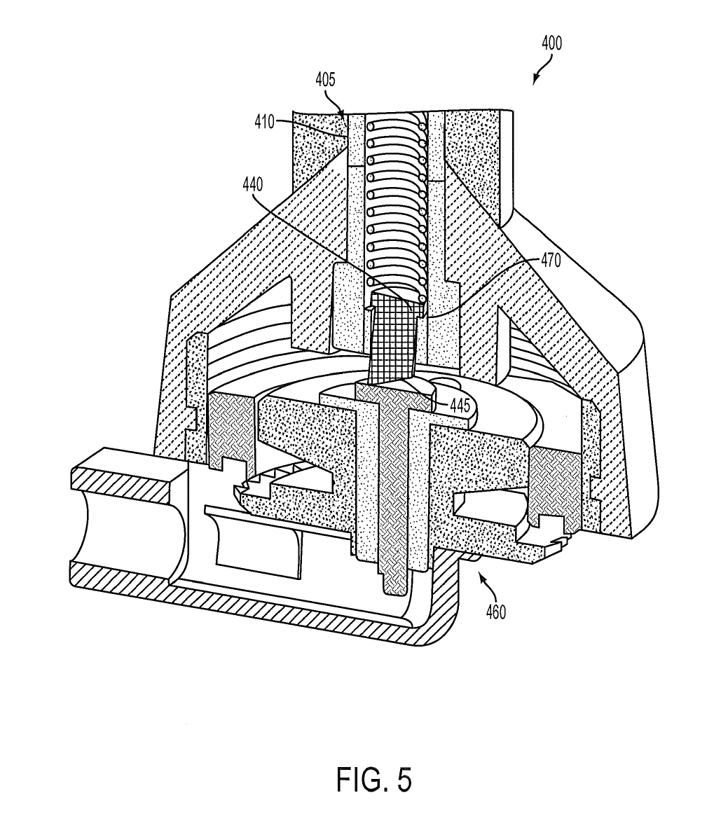

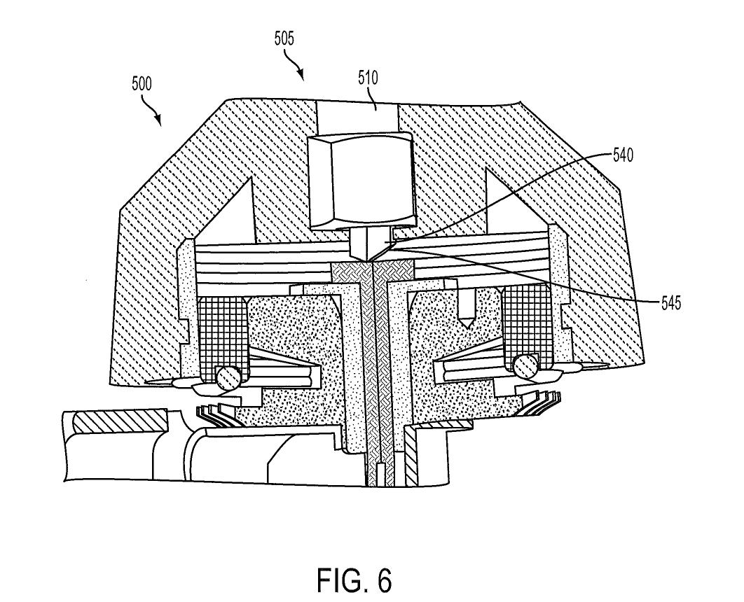

For example, FIG. 5 and FIG. 6 are cross-sectional views of antennas 400, 500 that include antenna push pin assemblies 405, 505 with positive contact antenna push pins 440, 540 engaged by respective antenna mounts 460, 660 in accordance with disclosed embodiments. As seen in the exemplary embodiment shown in FIG. 5, a surface of the base 445 of the positive contact antenna push pin 440 can be angled and/or mitered at a degree that is greater than or less than 90 degrees relative to the X axis of the positive contact antenna push pin 440 and/or from the Y axis of the positive contact antenna push pin 440. That is, the surface of the base 445 of the positive contact antenna push pin 440 need not be perpendicular to the side walls and/or the X axis of the positive contact antenna push pin 440 and need not be parallel to the Y axis of the positive contact antenna push pin 440. Indeed, in the embodiment shown in FIG. 5, a first side of the positive contact antenna push pin 440 can be longer than a second side of the positive contact antenna push pin 440, and a middle portion of the positive contact antenna push pin 440 can be longer than the second side, but shorter than the first side.

Similarly, as seen in the exemplary embodiment shown in FIG. 6, the base 545 of the positive contact antenna push pin 540 can be angled and/or mitered at a plurality of angles, where the degree of each angle is greater than or less than 90 degrees relative to the X axis of the positive contact antenna push pin 540 and/or from the Y axis of the positive contact antenna push pin 540. That is, the surface of the base 545 of the positive contact antenna push pin 540 need not be perpendicular to the side walls and/or the X axis of the positive contact antenna push pin 540 and need not be parallel to the Y axis of the positive contact antenna push pin 540. Indeed, in the embodiment shown in FIG. 6, a middle portion of the positive contact antenna push pin 540 can be longer than first and second sides of the positive contact antenna push pin 540, which can either have the same or different lengths as one another.

Other exemplary embodiments include a middle portion of the base of the positive contact antenna push pin being shorter than first and second sides of the base, and the first and second sides of the base having lengths that are different from one another and from the middle portion. Indeed, exemplary embodiments of the positive contact antenna push pin disclosed herein can include the base of the positive contact antenna push pin having any shape in which at least one portion and/or side of the base is longer than the remaining portions and/or sides of the base so that, when pushed or pressed by another object, the other object only engages the longest one side or portion of the base.

For example, in embodiments disclosed herein, when the antenna mount 460, 560 engages the positive contact antenna push pin 440, 540, the antenna mount 460, 560 is not flush with the surface of the base 345, 545 of the positive contact antenna push pin 440, 540 and only makes contact with a portion, for example, the longest side or portion of the positive contact antenna push pin 440, 540. Indeed, in the exemplary embodiment shown in FIG. 5, the antenna mount 460 only makes contact with the first side of the base 445 of the positive contact antenna push pin 440, and in the exemplary embodiment shown in FIG. 6, the antenna mount 560 only makes contact with the middle portion of the base 545 of the positive contact antenna push pin 540. Accordingly, the angle and shape of the base 445, 545 of the positive contact antenna push pin 440, 540 can cause the positive contact antenna push pin 440, 540 and the movement thereof to be biased when the antenna mount 460, 560 engages the positive contact antenna push pin 440, 540. That is, the positive contact antenna push pin 440, 540 can move within the housing 410, 510 in a direction that is not parallel to the X axis of the positive contact antenna push pin 440, 540. Accordingly, when engaged, the positive contact antenna push pin 440, 540 can move in the same predictable and repeatable direction that is not parallel to the X axis of the positive contact antenna push pin 440, 540 and contact the housing 410, 510 at the same predictable and repeatable electrical contact point, for example, contact point 470.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the spirit and scope of the claims.

What is claimed is:

1. A positive contact antenna push pin comprising:
a head; and
a shaft adjacent to the head, the shaft having a major axis along a length thereof and a minor axis along a width thereof,
wherein a surface of a base of the shaft is non-parallel and non-perpendicular to both the major axis and the minor axis of the shaft.

2. The positive contact antenna push pin of claim 1, wherein the surface of the base is disposed at a first angle relative to the major axis or the minor axis.

3. The positive contact antenna push pin of claim 2, wherein a first side of the shaft is longer than a second side of the shaft.

4. The positive contact antenna push pin of claim 3, wherein a middle portion of the shaft is shorter than the first side of the shaft and longer than the second side of the shaft.

5. The positive contact antenna push pin of claim 1, wherein the surface of the base is disposed at a plurality of different angles relative to the major axis or the minor axis.

6. The positive contact antenna push pin of claim 5, wherein a middle portion of the shaft is longer than first and second sides of the shaft.

7. The positive contact antenna push pin of claim 6, wherein a length of the first side of the shaft is equal to a length of the second side of the shaft.

8. The positive contact antenna push pin of claim 6, wherein the first side of the shaft is longer than the second side of the shaft.

9. The positive contact antenna push pin of claim 5, wherein a middle portion of the shaft is shorter than first and second sides of the shaft.

10. The positive contact antenna push pin of claim 9, wherein the first side of the shaft is longer than the second side of the shaft.

11. The positive contact antenna push pin of claim 1, wherein a first portion of the shaft is longer than every other portion of the shaft.

12. An antenna push pin assembly comprising:
a housing; and
a positive contact antenna push pin,
wherein the positive contact antenna push pin is biased so that, when engaged, the positive contact antenna push pin contacts a side wall of the housing at a predictable and repeatable contact point.

13. The antenna push pin assembly of claim 12, wherein the positive contact antenna push pin has a major axis along a length thereof and a minor axis along a width thereof, and wherein a surface of a base of the positive contact antenna push pin is non-parallel and non-perpendicular to both the major axis and the minor axis.

14. The antenna push pin assembly of claim 12, wherein a first portion of the positive contact antenna push pin is longer than every other portion of the positive contact antenna push pin.

15. The antenna push pin assembly of claim 12, wherein the positive contact antenna push pin has a major axis along a length thereof and a minor axis along a width thereof, and wherein when engaged, the positive contact antenna push pin moves within the housing in a direction that is non-parallel and non-perpendicular to both the major axis and the minor axis.

16. An antenna comprising:
an antenna mount; and
an antenna push pin assembly,
wherein the antenna push pin assembly includes a housing and a positive contact antenna push pin, and
wherein the positive contact antenna push pin is biased so that, when the antenna mount engages the positive contact antenna push pin, the positive contact antenna push pin contacts a side wall of the housing at a predictable and repeatable contact point.

17. The antenna of claim 16, wherein the positive contact antenna push pin has a major axis along a length thereof and a minor axis along a width thereof, and wherein a surface of a base of the positive contact antenna push pin is non-parallel and non-perpendicular to both the major axis and the minor axis.

18. The antenna of claim 16, wherein a first portion of the positive contact antenna push pin is longer than every other portion of the positive contact antenna push pin.

19. The antenna of claim 18, wherein, when the antenna mount engages the positive contact antenna push pin, the antenna mount engages only the first portion of the positive contact antenna push pin.

20. The antenna of claim 16, wherein the positive contact antenna push pin has a major axis along a length thereof and a minor axis along a width thereof, and wherein when engaged, the positive contact antenna push pin moves within the housing in a direction that is non-parallel and non-perpendicular to both the major axis and the minor axis.
